(19) United States
(12) Patent Application Publication
(10) Pub. No.: US 2014/0026892 A1
(43) Pub. Date: Jan. 30, 2014

(54) SURGICAL POSITIONING AID

(71) Applicants: Jesse S. Drake, Clinton, MA (US); Frederick K. Newey, Pelham, NH (US); Andrew D. Clark, Allston, MA (US)

(72) Inventors: Jesse S. Drake, Clinton, MA (US); Frederick K. Newey, Pelham, NH (US); Andrew D. Clark, Allston, MA (US)

(21) Appl. No.: 13/556,840

(22) Filed: Jul. 24, 2012

(51) Int. Cl. A61G 15/00

(52) U.S. Cl. 128/845

(57) ABSTRACT

A surgical positioning aid includes a sheet of foldable material foldable between a flat position and a wrist support position. In the wrist support position, the sheet is folded to form a hump having sufficient strength to support a patient's wrist in a hyper-extended position during surgery. The sheet also includes a coupler situated at a first end region of the sheet. The coupler is operable to engage an opposite, second end region of the sheet and to hold the sheet in the wrist support position. Many other surgical positioning aid embodiments are also disclosed.

### BACKGROUND

The present disclosure relates to a positioning aid, for supporting a patient during surgery. More particularly, the present disclosure relates to a support for positioning a portion of a patient's body during a surgery.

Often, when a patient is positioned for a surgery, the patient is supported by and secured to braces or supports coupled to a surgical table. Sometimes, positioning aids are inserted at the interface of the patient's body and the braces or supports to position a portion of the patient's body.

Positioning aids known in the art are often impromptu solutions provided by materials at hand at the time of a surgery or procedure. Aids such as pads, towels, or blocks can be difficult for caregivers to arrange and/or rearrange to position a patient as desired for surgery

### SUMMARY

A positioning aid has one or more of the features recited in the appended claims and/or the following features which, alone or in any combination, may comprise patentable subject matter:

A surgical positioning aid for positioning a patient's wrist is disclosed. The surgical positioning aid may include a sheet of foldable material. The sheet of foldable material may be foldable between a flat position and a wrist support position. In the support position, the sheet may be folded to form a hump having sufficient strength to support a patient's wrist during surgery. The sheet may also have a coupler at a first end region of the sheet. The coupler may engage a second end region of the sheet to hold the sheet in the wrist support position. The second end region may be opposite the first end region.

In some embodiments, the sheet may be foldable to a recovery position in which the sheet is folded over itself in a substantially flat configuration. In some such embodiments, the sheet of foldable material may include a locking coupler and a locking coupler receiver. The locking coupler may engage the locking coupler receiver when the sheet of foldable material is folded to the recovery position.

It is contemplated that the foldable sheet may include at least one living hinge about which the sheet is folded. In such embodiments, the at least one living hinge may form an apex of the hump having sufficient strength to support a patient's wrist during surgery.

The coupler at the first end region of the sheet may include a coupler tab bendable out of alignment with the sheet. In such embodiments, the second end region may include a series of coupler tab receivers formed through the sheet and sized to receive the coupler tab. The coupler tab may be defined by a U-shaped slot formed through the sheet.

According to this disclosure, therefore, a surgical positioning aid may include a flat sheet of foldable material having a first, a second, and a third portion. The first portion may be separated from the second portion by a first living hinge. The third portion may be separated from the second portion by a second living hinge. The sheet may also have a tab. The first portion of the sheet may also have at least one slot to receive the tab. Such a sheet may be movable between a flat position prior to use in surgery and a support position for surgery. In the support position, the second portion may be folded relative to the first portion about the first living hinge and the third portion may be folded relative to the second portion about the second living hinge. Further, the tab may be received in the at least one slot of the first portion such that the first and the second portions cooperate to form a hump relative to the first portion.

It is contemplated that the hump may include an apex formed by the second living hinge and that the apex may be spaced above the first portion of the sheet. The second living hinge may include at least two series of perforations formed through the sheet providing a gradual bend when the first living hinge is folded.

In some embodiments, the second portion may form a ramp between the first living hinge and the first portion. The third portion may form a ramp between the second living hinge and the tab.

The sheet may further be movable to a recovery position wherein the second portion is folded over the first portion about the first living hinge such that the second portion overlies and is substantially parallel to the first portion. In such embodiments, the third portion may be folded relative to the second portion about the second living hinge such that the second and the third portions are substantially flat relative to one another. The second portion of the sheet may include a first locking tab and the first portion of the sheet may include a first locking tab receiver sized to receive the first locking tab. The first locking tab may be received by the first locking tab receiver when the surgical positioning aid is moved to the recovery position so that the locking tab blocks the second portion from unfolding relative to the first portion about the first living hinge.

The sheet may be formed to include at least one strap slot sized for a strap to extend through the at least one strap slot. In such embodiments, the second portion may be formed to include a first strap slot and the third portion may be formed to include a second strap slot.

The sheet may include a fourth portion separated from the third portion by a third living hinge. The fourth portion may be formed to include a U-shaped slot defining the tab. The fourth portion may be folded relative to the third portion about the third living hinge so that the fourth portion overlies and is substantially parallel to the first portion when the surgical positioning aid is moved to the support position.

According to this disclosure, therefore, a surgical positioning aid for radial artery catheterization may be designed to allow for a hemostatic cuff to be in place during the procedure and subsequently applied without the repositioning of the patient's limb.

It is contemplated that the cuff is inflatable. The cuff may be made from a flexible material and may act like a tourniquet.

In some embodiments, the surgical positioning aid may include a means for securing the aid to a fixed surface. The surgical positioning aid may be operable to support a patient's entire arm. The surgical positioning aid may be made from a semi-rigid foam. The surgical positioning aid may include a thin rigid portion.

It is therefore disclosed that a surgical positioning aid for radial artery catheterization may include an arm support portion and a curved portion operable to position a patient's wrist in a hyper-extended position.

The surgical positioning may be configured to couple to a surgical table. In some embodiments, the surgical positioning aid may be radiolucent. The arm support portion may include a coupler portion configured to extend between a section of a surgical table and a mattress so that the surgical positioning aid is coupled to a surgical table.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures, in which:

FIG. 1 is a perspective view of a surgical positioning aid including a foldable sheet showing the sheet folded into a support position, the sheet supporting a patient's wrist in a hyper-extended position;

FIG. 2 is a perspective view of the surgical positioning aid of FIG. 1 showing the foldable sheet folded into a recovery position in which a patient's wrist is supported by the aid in a substantially flat configuration;

FIG. 3 is a top plan view of the surgical positioning aid of FIG. 1 showing the foldable sheet in a stored position wherein a base portion, an arm portion, a hand portion, and a tab portion are substantially flat;

FIG. 4 is a perspective view of the surgical positioning aid of FIG. 1 showing a coupler tab formed in the tab portion of the foldable sheet being bent out of the sheet for insertion into a coupler tab receiver formed in a base portion of the foldable sheet;

FIG. 5 is a perspective view of the surgical positioning aid of FIG. 1 showing the coupler tab inserted into the coupler tab receiver;

FIG. 6 is a side elevation view of the surgical positioning aid of FIG. 1 showing the foldable sheet in a support position and the arm portion cooperating with the hand portion of the foldable sheet forming a hump for supporting a patient's wrist at a low angle of hyper-extension;

FIG. 7 is a side elevation view of the surgical positioning aid of FIG. 1 showing the foldable sheet in a support position and the arm portion cooperating with the hand portion of the foldable sheet forming a hump for supporting a patient's wrist at a medium angle of hyper-extension;

FIG. 8 is a side elevation view of the surgical positioning aid of FIG. 1 showing the foldable sheet in a support position and the arm portion cooperating with the hand portion of the foldable sheet forming a hump for supporting a patient's wrist at a high angle of hyper-extension;

FIG. 9 is a perspective detail view of the surgical positioning aid of FIG. 1 showing a lock tab formed in the arm portion of the foldable sheet and a lock tab receiver formed in the base portion of the foldable sheet;

FIG. 10 is a perspective detail view of the surgical positioning aid of FIG. 1 showing the lock tab bent down and into engagement with the lock tab receiver;

FIG. 11 is a side elevation detail view of the surgical positioning aid of FIG. 1 showing the lock tab bent down and into engagement with the lock tab receiver blocking the arm portion of the foldable sheet from unfolding away from the base portion of the foldable sheet;

FIG. 12 is a perspective view of an alternative surgical positioning aid supporting a patient's wrist in a hyper-extended position, the aid including a block with a convex top profile between an arm end and a hand end of the block, the aid also including an arm strap, a hand strap, and an inflatable cuff;

FIG. 13 is a side elevation view of the surgical positioning aid of FIG. 12 showing the block including an arm strap slot, a hand strap slot, and a cuff slot;

FIG. 14 is a cross-sectional view taken along line 14-14 of FIG. 13 showing a concave profile between a left and a right side of the block for centering a patient's wrist when the patient's wrist is supported on the body;

FIG. 15 is a side elevation view of an alternative surgical positioning aid including a block with a convex top profile between an arm end and a hand end, the aid also including a first strap groove and a second strap groove;

FIG. 16 is a side elevation view of an alternative surgical positioning aid including a thin body forming a convex profile extending between an arm end and a hand end of the body to support a patient's wrist in a hyper-extended position;

FIG. 17 is a cross sectional view taken along line 17-17 of FIG. 16 showing a concave profile of the body between a right and a left side of the body for centering a patient's wrist when the patient's wrist is supported on the body;

FIG. 18 is a side elevation view of an alternative surgical positioning aid including a thin body, a first flat coupling portion extending beyond an arm end of the body, and a second flat coupling portion extending beyond a hand end of the body, the thin body forming a convex profile extending between an arm end and a hand end of the body to support a patient's wrist in a hyper-extended position;

FIG. 19 is a top plan view of an alternative surgical positioning aid showing the aid in a flat stored configuration, the aid including a T-shaped body with a strap extending through slots formed in a stem of the body;

FIG. 19A is a side elevation view of the surgical positioning aid of FIG. 19 showing the aid in a support position for supporting a patient's wrist in a hyper-extended position and the aid coupled to an arm board by a strap and a pair of wings;

FIG. 20 is a top plan view of an alternative surgical positioning aid showing the aid in a flat stored configuration, the aid including an I-shaped body;

FIG. 20A is a side elevation view of the surgical positioning aid of FIG. 20 showing the aid in a support position for supporting a patient's wrist in a hyper-extended position and the aid coupled to an arm board by wings at both ends of a stem;

FIG. 21 is a side elevation view of the surgical positioning aid of FIG. 20 showing the aid in a flat stored configuration;

FIG. 22 is a side elevation view of an alternative surgical positioning aid including a contoured pad with an arm support portion unitarily formed with a block portion, the arm support portion configured to support a patient's whole arm and the block portion including a convex top profile for supporting a patient's wrist in a hyper-extended position;

FIG. 23 is a side elevation view of an alternative surgical positioning aid for use with a thin mattress pad including a thin body portion, a thin arm support portion, and a thin pad, the thin body portion configured to support a patient's wrist in a hyper-extended position and the thin arm support portion configured to support a patient's whole arm;

FIG. 24 is a side elevation view of an alternative surgical positioning aid for use with a thick mattress pad including a thin body portion, a step portion, a thin arm support portion, and a thin pad, the thin body portion configured to support a patient's wrist in a hyper-extended position and the thin arm support portion configured to support a patient's whole arm;

FIG. 25 is a side elevation view of an alternative surgical positioning aid including an inflatable bladder, an arm strap, and a hand strap wherein the inflatable bladder is situated beneath a patient's wrist and is inflatable to support a patient's wrist in a hyper-extended position;

FIG. 26 is a side elevation view of the surgical positioning aid of FIG. 25 showing the inflatable bladder in a deflated position moving a patient's wrist to a substantially flat recovery position; and

FIG. 27 is a side elevation view of an alternative surgical positioning aid including a block with a decline ramp and a removable slug configured to be situated between the decline ramp and a patient's hand when the patient's wrist is moved to a substantially flat recovery position.

### DETAILED DESCRIPTION

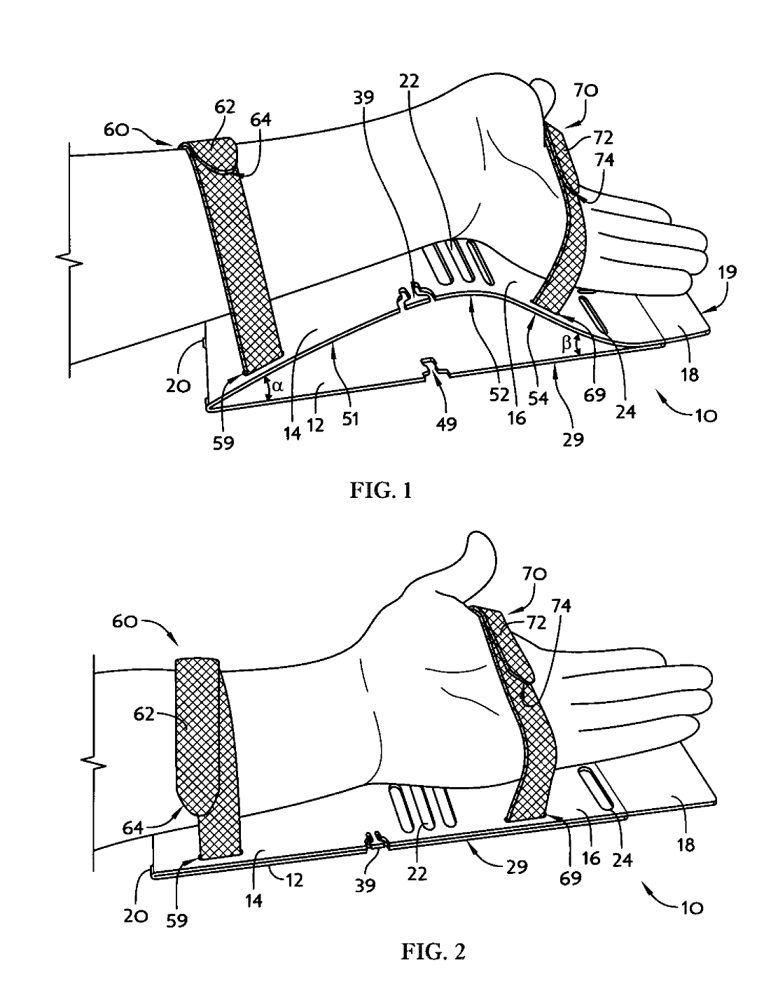

An illustrative surgical positioning aid 10 used for positioning a patient's arm, hand, and wrist during and after trans-radial cardiac catheterizations is shown in FIG. 1. In other embodiments, the surgical positioning aid 10 may be scaled up or down in size for positioning other parts of a patient during other surgeries or operations including but not limited to: positioning a patient's knee relative to a patient's hip during hip surgery or positioning a patient's head relative to a patient's torso for tracheal tube placement.

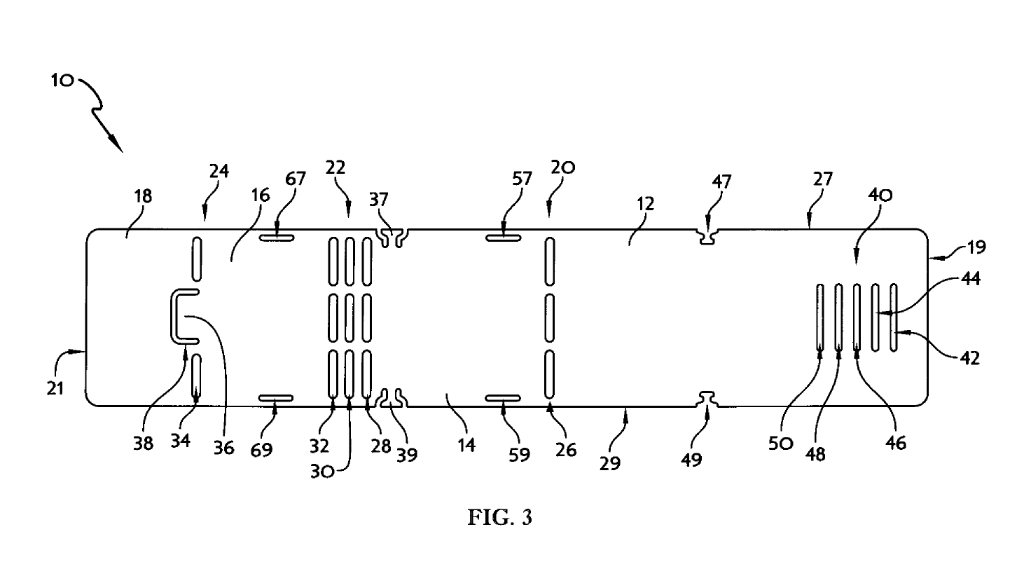

The aid 10 is illustratively a sheet of plastics material and includes a base portion 12, an arm portion 14, a hand portion 16, and a tab portion 18. The base portion 12 is situated at a first edge 19 of the aid 10. The tab portion 18 is situated at a second edge 21 of the aid 10. The aid 10 is movable between a flat position for storage (as shown in FIG. 3), a support position for supporting a patient's arm, hand, and wrist, while the patient's wrist is in a hyper-extended position during trans-radial cardiac catheterizations (as shown in FIG. 1), and a recovery position for supporting a patient's arm, hand, and wrist during recovery from trans-radial cardiac catheterizations (as shown in FIG. 2).

The base portion 12 of the aid 10 is coupled to the arm portion 14 by a first living hinge 20 situated between the base portion 12 and the arm portion 14. The arm portion 14 of the aid 10 is coupled to the hand portion 16 by a second living hinge 22 situated between the arm portion 14 and the hand portion 16. The hand portion 16 of the aid 10 is coupled to the tab portion 18 by a third living hinge 24 situated between the hand portion 16 and the tab portion 18.

The first living hinge 20 is formed by a series of perforations 26 extending through the aid 10 arranged in a linear pattern between a top edge 27 and a bottom edge 29 of the aid 10. The first living hinge 20 is configured to provide sharp bend between the base portion 12 and the arm portion 14. In other embodiments, the first living hinge 20 may be formed by a thinned section of the aid 10 between the base portion 12 and the arm portion 14.

The second living hinge 22 is illustratively formed by a first series of perforations 28, a second series of perforations 30, and a third series of perforations 32 extending through the aid 10 and arranged in linear patterns between the top edge 27 and the bottom edge 29 of the aid 10. The second living hinge 22 is configured to provide gradual bend between the arm portion 14 and the hand portion 16. In other embodiments, the second living hinge 22 may be formed by a thinned section of the aid 10 between the arm portion 14 and the hand portion 16. In such embodiments, the thinned section of the second living hinge may extend a greater distance between the first edge 19 and the second edge 21 of the aid 10 than a thinned section forming the first living hinge.

The third living hinge 24 is formed by a series of perforations 34 extending through the aid 10 arranged in a linear pattern between the top edge 27 and the bottom edge 29 of the aid 10 as shown in FIG. 3. The third living hinge 24 is configured to provide a sharp bend between the hand portion 16 and the tab portion 18. In other embodiments, the third living hinge 24 may be formed by a thinned section of the aid 10 between the hand portion 16 and the tab portion 18.

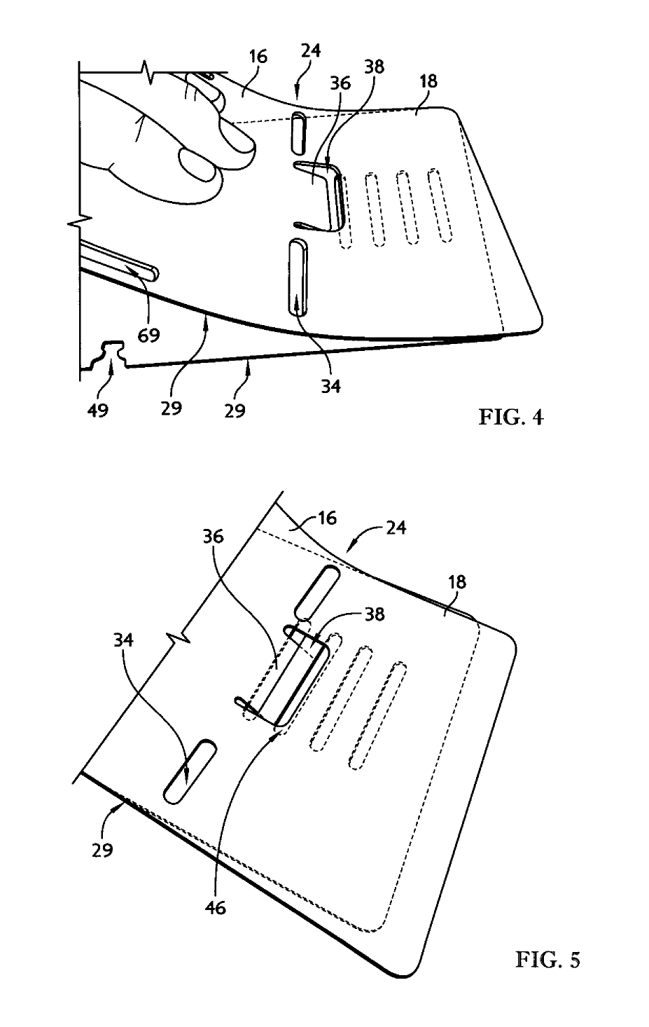

The tab portion 18 of the aid 10 includes a coupler tab 36 for selectively securing the hand portion 16 to the base portion 12. The coupler tab 36 is defined by a U-shaped slot 38 formed through the aid 10. The coupler tab 36 is configured to be bent down from the aid 10 by a caregiver as shown in FIG. 4. In some embodiments, rather than the coupler tab 36, an adhesive, complementary patches of hook and loop material, or another securing arrangement may be used for selectively securing the hand portion 16 to the base portion 12.

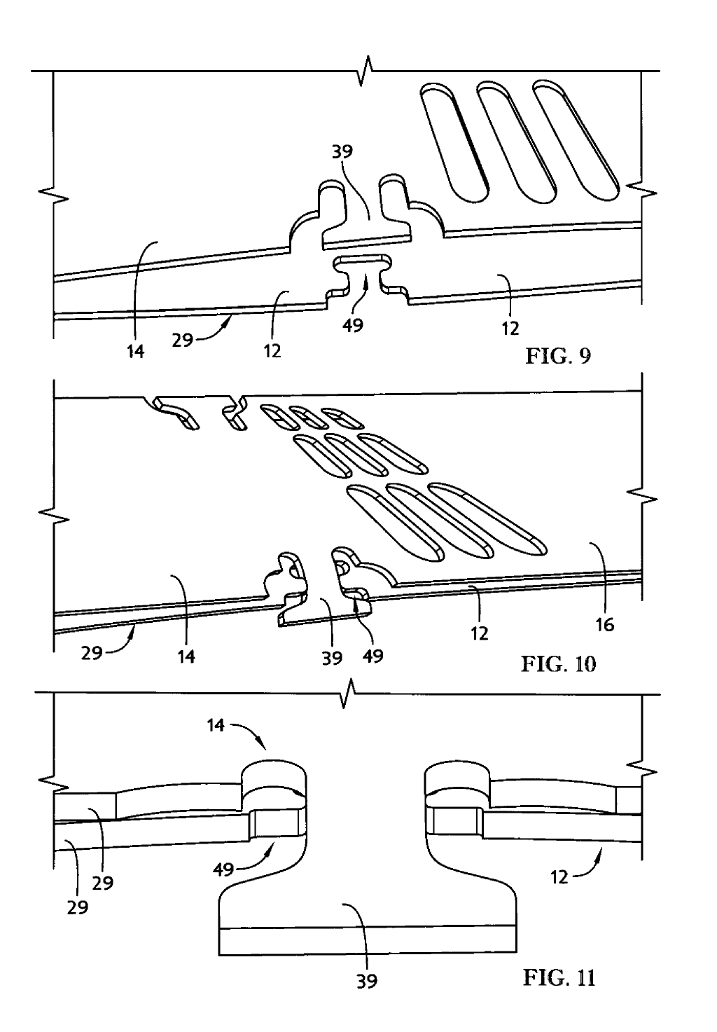

The arm portion 14 of the aid 10 includes a first lock tab 37 and a second lock tab 39. The first lock tab 37 is formed along the top edge 27 of the aid 10. The second lock tab 39 is formed along the bottom edge 29 of the aid 10. The first and the second lock tabs 37, 39 are configured to be bent down from the aid 10 by a caregiver as shown in FIG. 9.

As shown in FIG. 3, the base portion 12 of the aid 10 includes a series of coupler tab receivers 40 extending through the aid 10 and sized to receive the coupler tab 36. The series of coupler tab receivers 40 includes coupler tab receivers 42, 44, 46, 48, 50. The base portion 12 also includes a first lock tab receiver 47 and a second lock tab receiver 49. The first lock tab receiver 47 is formed in the top edge 27 of the aid 10 and the second lock tab receiver 49 is formed in the bottom edge 29 of the aid 10. The first and the second lock tab receivers 47, 49 are sized to receive the first lock tab 37 and the second lock tab 39, respectively.

When the aid 10 is in the stored position, the aid 10 is substantially flat. Also, the base portion 12 is spaced apart from the tab portion 18. Further, neither the coupler tab 36 nor the first and the second lock tabs 37, 39 are bent down from the aid 10. Thus, the aid 10 is easily stored or stacked in the stored position.

To move the aid 10 from the stored position to the support position, the first living hinge 20 is bent so that the arm portion 14 extends over the base portion 12 forming an angle α between the base portion 12 and the arm portion 14. Thus, the base portion 12 and the arm portion 14 form a first ramp 51. Additionally, the second living hinge 22 is gradually bent so that the second living hinge 22 forms an apex 52 spaced above the base portion 12. Further, the hand portion 16 extends from the apex 52 to the base portion 12 so that the hand portion 16 extends over the base portion 12 forming an angle β between the base portion 12 and the hand portion 16. Thus, the base portion 12 and the hand portion 16 form a second ramp 54. Finally, the third living hinge 24 is bent so that the tab portion 18 overlies and is substantially parallel to the base portion 12. In some embodiments, additional straps may be wrapped around the base portion 12 and an arm board or other support to secure the aid 10 relative to an overall patient support. In other embodiments, the base portion 12 may include additional tabs that are operable to be bent down and secured to an arm board having slots to receive the additional tabs, thereby securing the aid relative to an overall patient support.

When the aid 10 is moved to the support position, the arm portion 14 is operable to support a patient's arm, the hand portion 16 is operable to support a patient's hand, and the second living hinge 22 is operable to support a patient's wrist in a hyper-extended position suitable for catheterization. Also, the coupler tab 36 is bent down from the tab portion 18 of the aid 10 and is inserted into one of coupler tab receivers 42, 44, 46, 48, 50 so that the positions of the arm portion 14 and the hand position 16 are maintained relative to the base portion 12.

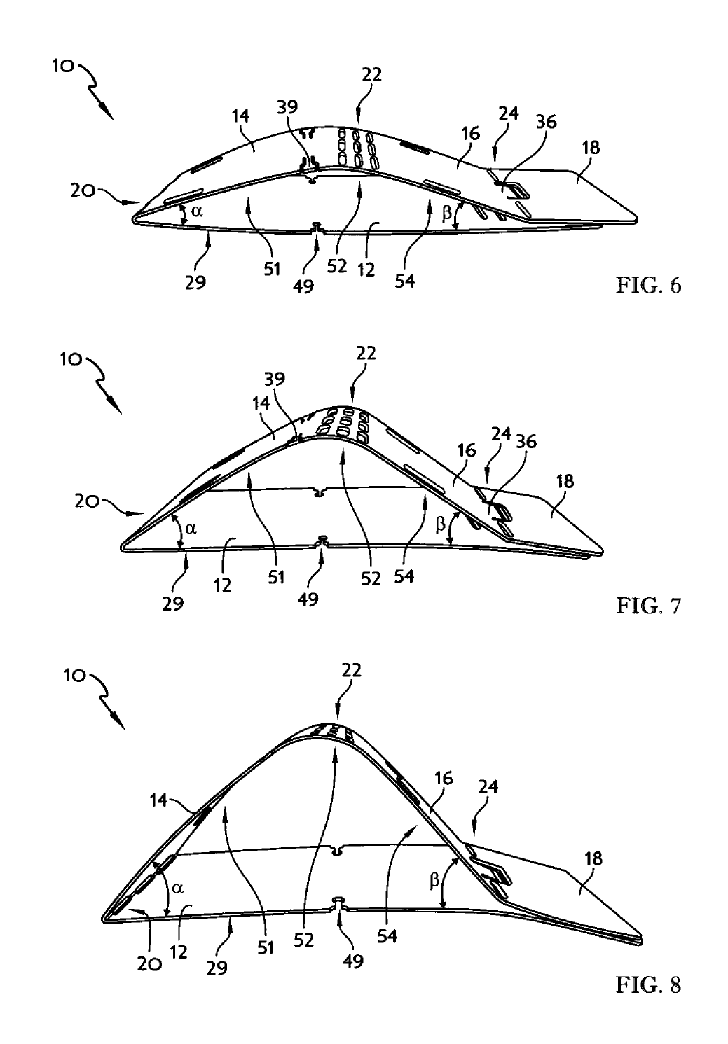

In the support position, the angles α, β are adjustable depending on which coupler tab receiver 42, 44, 46, 48, 50 receives the coupler tab 36. Thus, a physician may adjust the angle at which a patient's wrist is hyper-extended among a series of angles as shown in FIGS. 6-8. The physician may adjust the angle of hyper-extension for a catheterization depending on physician preference, patient flexibility, and other factors. In some embodiments, while the aid 10 is in the support position, the angle of a patient's hyper-extended wrist may be between 35 and 65 degrees. In some embodiments an occlusion band may have an inflatable hemostatic cuff and the occlusion band may be passed between the base portion 12 and the overlying arm portion 14 for use before, after or during a catheterization. In some such embodiments, the occlusion band may be made from a flexible material and may act as a tourniquet.

To move the aid 10 from the support position to the recovery position, the first living hinge 20 is further bent so that the arm portion 14 overlies and is substantially parallel to the base portion 12. Additionally, the second living hinge 22 is unbent so that the hand portion 16 is flattened relative to the arm portion 14. Further, the hand portion 16 in the recovery position overlies and is substantially parallel to the base portion 12. In the recovery position, the angle α is about 180 degrees and the angle β is about 0 degrees. Thus, in the recovery position, a patient's wrist is moved away from the hyper-extended position.

When the aid 10 is moved to the recovery position, the arm portion 14 is operable to support a patient's arm, the hand portion 16 is operable to support a patient's hand, and the second living hinge 22 is operable to support a patient's wrist in a substantially flattened position suitable for recovery. Also, the coupler tab 36 is removed from the coupler tab receivers 42, 44, 46, 48, 50 and is moved back into alignment with the aid 10. Additionally, the lock tabs 37, 39 are bent down from the arm portion 14 and are inserted into the lock tab receivers 47, 49, respectively. When the lock tabs 37, 39 are inserted into the lock tab receivers 47, 49 the aid 10 is locked in the recovery position. The lock tabs 37, 39 are operable to move into and out of the lock tab receivers 47, 49 while a patient's arm, hand, and wrist are supported on the aid 10. Thus, the aid 10 is movable from the support position to the recovery position while a patient's arm, hand, and wrist remain supported on the aid 10. In some embodiments an occlusion band may have an inflatable hemostatic cuff and the band may be passed between the base portion 12 and the overlying arm portion 14 so that the occlusion band may be secured over a patient's arm to slow circulation to a catheter insertion point before, during or after a catheterization. In some such embodiments, the occlusion band may be made from a flexible material and may act as a tourniquet.

The arm portion 14 also includes a first arm strap slot 57, a second arm strap slot 59, and an arm strap 60. The first and the second arm strap slots 57, 59 extend through the aid 10 and are situated near the top and the bottom edges 27, 29 of the aid, respectively. The arm strap 60 extends through the first and the second arm strap slot 57, 59 and is operable to be wrapped around and secure a patient's arm to the arm portion 14 of the aid 10. In the illustrative embodiment, the arm strap 60 includes a hook material face 62 and a loop material face 64 so that the arm strap 60 can be secured to itself. In other embodiments, the arm strap 60 may include clasps, hooks, snaps or the like to secure a patient's arm to the arm portion 14 of the aid 10.

The hand portion 16 also includes a first hand strap slot 67, a second hand strap slot 69, and a hand strap 70. The first and the second hand strap slots 67, 69 extend through the aid 10 and are situated near the top and the bottom edges 27, 29 of the aid, respectively. The hand strap 70 extends through the first and the second hand strap slots 67, 69 and is operable to be wrapped around and secure a patient's hand to the hand portion 16 of the aid 10. In the illustrative embodiment, the hand strap 70 includes a hook material face 72 and a loop material face 74 so that the hand strap 70 can be secured to itself. In other embodiments, the hand strap 70 may include clasps, hooks, snaps or the like to secure a patient's hand to the hand portion 16 of the aid 10.

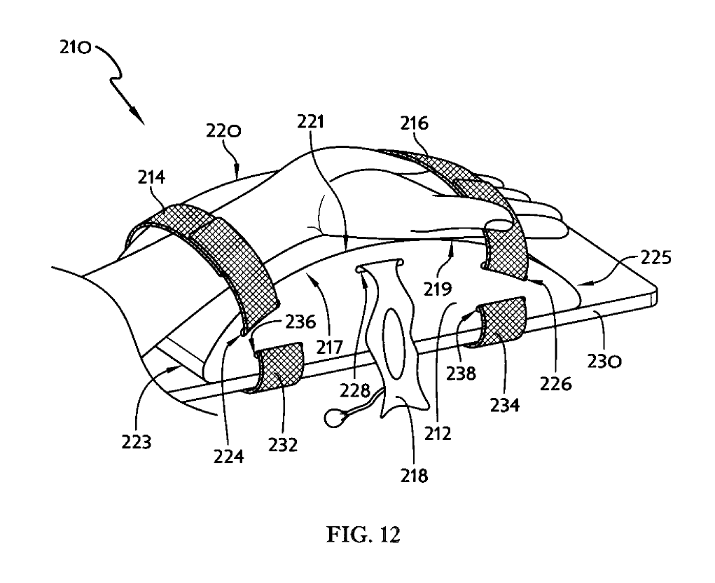

An alternative positioning aid 210 is shown in FIGS. 12-14. The positioning aid 210 includes a block 212, an arm strap 214, a hand strap 216, and an inflatable cuff 218. The block 212 has a convex profile 220 extending longitudinally across the top of the block 212 between an arm end 223 and a hand end 225 of the block 212 as shown in FIGS. 12 and 13. The convex profile 220 forms an incline ramp 217, a decline ramp 219, and an apex 221. The incline ramp 217 extends from the arm end 223 of the block to the apex 221 and is operable to support a patient's arm. The decline ramp 219 extends from the apex 221 to the hand end 225 of the block 212 and is operable to support a patient's hand. The convex profile 220 is operable to support a patient's wrist in a hyper-extended position as shown in FIG. 12.

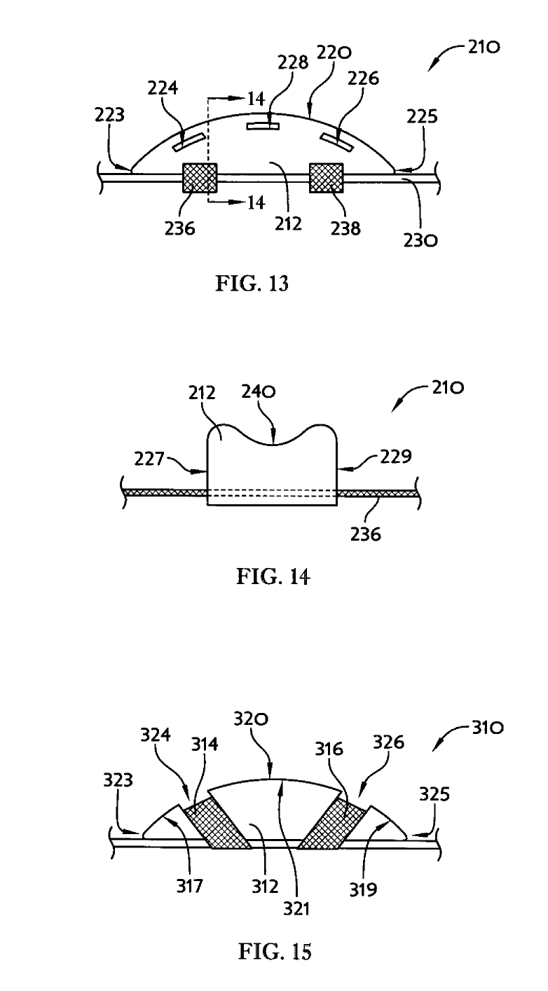

The block 212 forms an arm strap slot 224, a hand strap slot 226, and a cuff slot 228. The arm strap slot 224 extends through the block 212 and is oriented to run between a left side 227 and a right side 229 of the block as shown in FIG. 14. Additionally, the arm strap slot 224 is situated near the arm end 223 of the block 212. The hand strap slot 226 extends through the block 212 and is oriented to run between the left side 227 and the right side 228 of the block 212. The hand strap slot 226 is situated near the hand end 225 of the block 212. The cuff slot 228 extends through the block 212 and is oriented to run between the left side 227 and the right side 229 of the block 212. The cuff slot 228 is situated between the arm strap slot 224 and the hand strap slot 226 as shown in FIGS. 12 and 13.

The arm strap 214 is sized to extend through the arm strap slot 224 and is operable to wrap around and secure a patient's arm to the block 212. The hand strap 216 is sized to extend through the hand strap slot 226 and is operable to wrap around and secure a patient's hand to the block 212. The inflatable cuff 218 is sized to extend through the cuff slot 228 and is operable to occlude arteries in the arm after a trans-radial cardiac catheterization or other procedure.

The positioning aid 210 is configured to be coupled to an arm board 230 and also includes a first board strap 232 and a second board strap 234. The block 212 is illustratively made of foam and includes a first board strap slot 236 and a second board strap slot 238. The first and the second board straps 236, 238 extend through the block 212 and run between the left side 227 and the right side 229 of the block 212. The first and the second board straps 232, 234 are operable to wrap around the arm board 230 and to secure the block 212 to the arm board 230.

The block 212 has a concave profile 240 extending laterally across the top of the block 212 between the left side 227 and the right side 229 of the block 212 as shown in FIG. 14. The concave profile 240 is operable to center a patient's wrist supported by the block 212. The concave profile 240 extends along the entire length of the block 212.

Another alternative positioning aid 310 is shown in FIG. 15. The positioning aid 310 includes a block 312, a first board strap 214, and a second board strap 216. The block 312 is illustratively made of foam and has a convex profile 320 extending longitudinally across the top of the block 312 between an arm end 323 and a hand end 325 of the block 312 as shown in FIG. 15. The convex profile 320 forms an incline ramp 317, a decline ramp 319, and an apex 321. The incline ramp 317 extends from the arm end 323 of the block to the apex 321 and is operable to support a patient's arm. The decline ramp 319 extends from the apex 321 to the hand end 325 of the block 312 and is operable to support a patient's hand. The convex profile 320 is operable to support a patient's wrist in a hyper-extended position.

The block 312 forms a first strap groove 324 and a second strap groove 326. The first and the second strap grooves 324, 326 extend downwardly from the convex profile 320 of the block 312. The first and the second strap grooves 324, 326 are also sized to receive the first and the second board straps 314, 316, respectively. As shown in FIG. 15, the first and the second board straps 314, 316 overlie the block 212 in the strap grooves 324, 326 and are operable to secure the block 312 to an arm board 330. In some embodiments, the positioning aid 310 may include an arm strap and a hand strap operable to wrap around a patient's arm and hand securing the patient to the block 312.

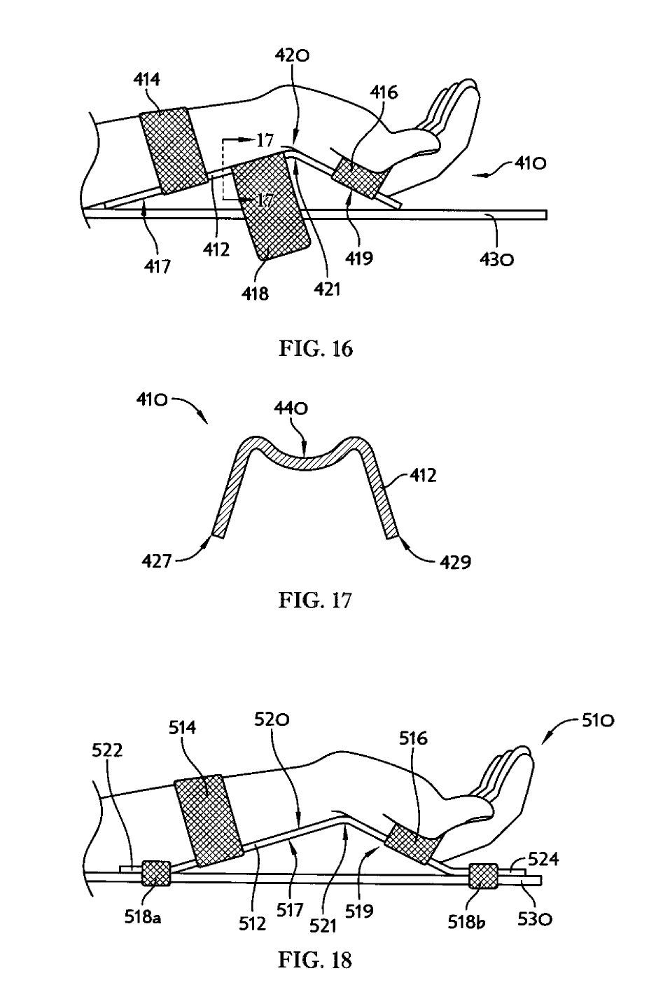

Still another alternative positioning aid 410 is shown in FIG. 16-17. The positioning aid 410 includes a thin rigid body 412, an arm strap 414, a hand strap 416, and a board strap 418. The body 412 is illustratively made from a sheet of plastics material and has a thickness of about ⅛^{th} inch to about 1 inch. The body 12 has a convex profile 420 extending longitudinally across the top of the body 412 between an arm end 423 and a hand end 425 of the body 412 as shown in FIG. 16. The convex profile 420 forms an incline ramp 417, a decline ramp 419, and an apex 421. The incline ramp 417 extends from the arm end 423 of the body 412 to the apex 421 and is operable to support a patient's arm. The decline ramp 419 extends from the apex 421 to the hand end 425 of the body 412 and is operable to support a patient's hand. The convex profile 420 is operable to support a patient's wrist in a hyper-extended position as shown in FIG. 16.

The arm strap 414 wraps around the incline ramp 417 and is operable to wrap around a patient's arm to secure the patient's arm to the incline ramp 417. The hand strap 416 wraps around the decline ramp 419 and is operable to wrap around a patient's hand to secure the patient's hand to the decline ramp 419. The board strap 418 is situated near the apex 421 of the body 412 and is illustratively secured to the body 412 by an adhesive. The board strap 418 is operable to wrap around an arm board 430 to secure the positioning aid 410 to the arm board 430.

The body 412 has a concave profile 440 extending laterally across the top of the body 412 between a left side 427 and a right side 429 of the body 412 as shown in FIG. 17. The concave profile 440 is operable to center a patient's wrist supported by the body 412. The concave profile 440 extends along the entire length of the body 412.

Another alternative positioning aid 510 is shown in FIG. 18. The positioning aid 510 includes a thin rigid body 512, an arm strap 514, a hand strap 516, a first board strap 518a, and a second board strap 518b. The body 512 is illustratively made from a sheet of plastics material and has a thickness of about ⅛^{th} inch to about 1 inch. The body 12 has a convex profile 520, a first flat coupling portion 522, and a second flat coupling portion 524. The convex profile 520 extends longitudinally across the top of the body 512 between the first and the second flat coupling portions 522, 524. The first flat coupling portion 522 extends from an arm end 523 of the body 512 to the beginning of the convex profile 520. The second flat coupling portion 524 extends from a hand end 525 of the body 512 to the convex profile 520.

The convex profile 520 forms an incline ramp 517, a decline ramp 519, and an apex 521. The incline ramp 517 extends from the arm end 523 of the body 512 to the apex 521 and is operable to support a patient's arm. The decline ramp 519 extends from the apex 521 to the hand end 525 of the body 512 and is operable to support a patient's hand. The convex profile 520 is operable to support a patient's wrist in a hyper-extended position as shown in FIG. 18.

The arm strap 514 wraps around the incline ramp 517 and is operable to wrap around a patient's arm to secure the patient's arm to the incline ramp 517. The hand strap 516 wraps around the decline ramp 519 and is operable to wrap around a patient's hand to secure the patient's hand to the decline ramp 519. The first and the second board strap 518a, 518b wraps around the first and the second flat coupling portion 522, 524, respectively, and an arm board 530 to secure the positioning aid 510 to the arm board 530.

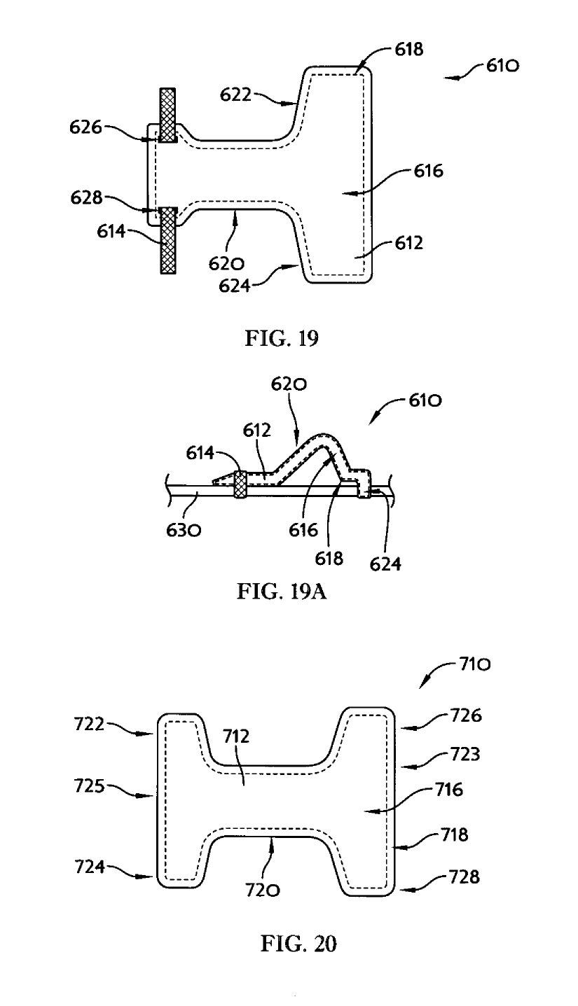

Yet another alternative positioning aid 610 is shown in FIGS. 19 and 19A. Aid 610 includes a pliable body 612 and a securing strap 614. The body 612 is made from an annealed aluminum sheet core 616 coated in an ethylene foam coating 618. In other embodiments, the core 616 may be made from some other flexible material and the coating 618 may be some other material such as a gel, a plastic, or another foam.

The body 612 is T-shaped with a stem 620 and wings 622, 624 extending laterally away from the stem 620. The stem 620 is formed to include a first and a second strap slot 626, 628 near an arm end 623 of the body 612. The wings 622, 624 form a hand end 625 of the body 612. The securing strap 614 extends through the first and the second strap slot 626, 628. The securing strap 614 is operable to be wrapped around an arm board 630 to secure the aid 610 to the arm board 630.

The body 612 is movable between a storage position where the body 612 is flat and a support position where the stem 620 of the body 612 is bent to form an incline ramp 617, a decline ramp 619, and an apex 621 as shown in FIG. 19A. The incline ramp 617 extends from the arm board 630 to the apex 621 and is operable to support a patient's arm. The decline ramp 619 extends from the apex 621 to arm board 630 and is operable to support a patient's hand. The body 612 in the support position is operable to support a patient's wrist over the apex 621 in a hyper-extended position. Also, when the body is moved to the support position, the wings 622, 624 are bent down to wrap around an arm board. Further, when the body 612 is moved to the support position, the securing strap 614 is wrapped around the arm board securing the aid 610 to the arm board. In some embodiments, the body 612 is further bent in the support position to form a convex shape between a left and a right side of the body 12.

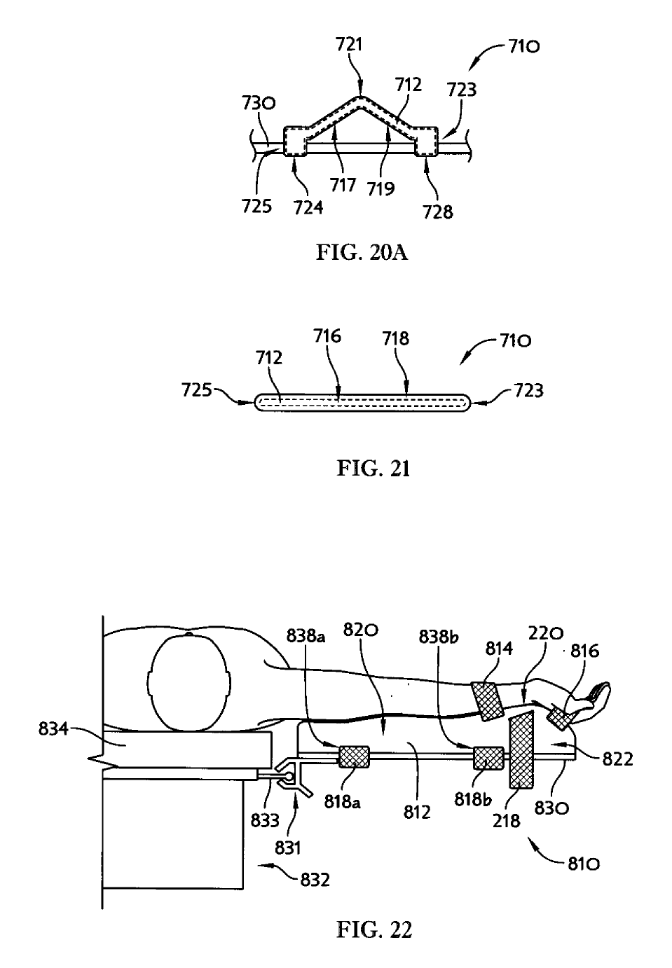

Another alternative positioning aid 710 is shown in FIGS. 20, 20A, and 21. Aid 710 includes a pliable body 712 made from an annealed aluminum sheet core 716 coated in an ethylene foam coating 718. In other embodiments, the core 716 may be made from some other flexible material and the coating 718 may be some other material such as a gel, a plastic, or another foam.

The body 712 is I-shaped with a stem 720, hand wings 722, 724 and arm wings 726, 728. The hand wings 722, 724 extend laterally away from the stem 720 and form a hand end 725 of the body 712. The arm wings 726, 728 extend laterally away from the stem 720 and form an arm end of the body 723.

The body 712 is movable between a storage position where the body 712 is flat (as shown in FIG. 21) and a support position where the stem 720 of the body 712 is bent to form an incline ramp 717, a decline ramp 719, and an apex 721 as shown in FIG. 20A. The inclined ramp 717 extends from the arm board 730 to the apex 721 and is operable to support a patient's arm. The decline ramp 719 extends from the apex 721 to arm board 730 and is operable to support a patient's hand. The body 712 in the support position is operable to support a patient's wrist at the apex 721 in a hyper-extended position. Also, when the body is moved to the support position, the hand wings and the arm wings 722, 724, 726, 728 are bent down to wrap around an arm board as shown in FIG. 20A. In some embodiments, the body 712 is further bent in the support position to form a convex shape between a left and a right side of the body 712.

Still another positioning aid 810 is shown in FIG. 22. Positioning aid 810 includes a contoured pad 812, an arm strap 814, a hand strap 816, a first board strap 818a, and a second board strap 818b. The contoured pad 812 is illustratively made of foam and includes an arm support portion 820 unitarily formed with a block portion 822. The block portion 822 is substantially similar to the positioning aid 210 in FIGS. 12-14 and similar reference numbers are used to denote like features.

The arm support portion 820 extends along the length of an arm board 830. In some embodiments, the arm board 830 and the positioning aid 810 are radiolucent to allow imaging of a patient supported on the aid 810. The arm board 830 includes a clamp 831 and is operable to couple to an operating room table 832 with an accessory rail 833. The arm support portion is sized to have a thickness similar to that of a mattress 834 supported on the operating room table 832. The arm support portion 820 includes a first arm strap slot 838a and a second arm strap slot 838b spaced apart from one another. The first and the second board straps 818a, 818b extend through the first and the second arm strap slots 838a, 838b and wrap around the arm board 830 to secure the positioning aid 810 to the arm board 830.

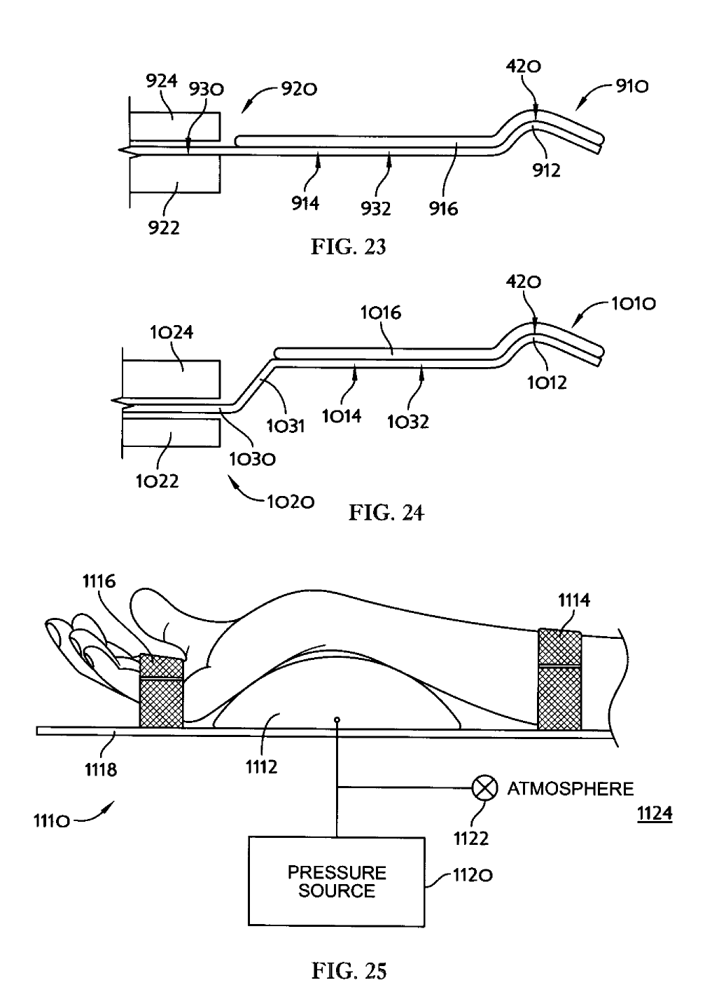

Yet another positioning aid 910 is shown in FIG. 23. The positioning aid 910 includes a thin body portion 912, a thin arm support portion 914, and a thin pad 916. The thin body portion 912 is unitarily formed with the thin arm support 914 and both are illustratively made of a sheet of plastics material with a thickness of about ⅛^{th} inch to about 3 inches. In other embodiments, the thin body portion 912 and the thin arm support 914 may be made from carbon fiber, wood, or some other suitable material. The thin body portion 912 is substantially similar to the positioning aid 410 shown in FIGS. 16 and 17 and similar reference numbers are used to denote like features.

The positioning aid 910 is configured to be used with an operating room table 920 with a table section 922 and a thin mattress pad 924. The thin arm support 914 includes a coupling portion 930 and a support portion 932. The coupling portion 930 of the thin arm support 914 extends between the table section 922 and the thin mattress pad 924 such that the aid 910 is held in place relative to the operating room table 920. The aid 910 is further held in place relative to the operating room table 920 by a patient's weight when a patient is supported on the mattress pad 924. The support portion 932 of the thin arm support 914 extends between the thin mattress pad 924 and the thin body portion 912 and is operable to support a patient's arm.

The thin pad 916 is illustratively a gel pad with a thickness of about ⅛^{th} inch to about 1 inch. The thin pad 916 overlies the thin body portion 912 and the support portion 932 of the thin arm support 914. In other embodiments, the thin pad 916 may be made from foam or other padding material. In some embodiments, the thin body 912, the thin arm support 914, and the thin pad 916 may be covered by a disposable cover.

Another alternative positioning aid 1010 is shown in FIG. 24. The positioning aid 1010 includes a thin body portion 1012, a thin arm support 1014, and a thin pad 1016. The thin body portion 1012 is unitarily formed with the thin arm support 1014 and both are illustratively made from a sheet of plastics material with a thickness of about ⅛^{th} inch to about 3 inches. The thin body portion 1012 is substantially similar to the positioning aid 410 shown in FIGS. 16 and 17 and similar reference numbers are used to denote like features.

The positioning aid 1010 is configured to be used with an operating room table 1020 with a table section 1022 and a thick mattress pad 1024. The thin arm support 1014 has a coupling portion 1030, a step portion 1031, and a support portion 1032 all illustratively made from a plastics material. In other embodiments, the thin arm support 1014 may be made from carbon fiber, wood, or some other suitable material. The coupling portion 1030 of the thin arm support 1014 extends between the table section 1022 and the thick mattress pad 1024 such that the aid 1010 is held in place relative to the operating room table 1020. The aid 1010 is further held in place relative to the operating room table 1020 by a patient's weight when a patient is supported on the mattress pad 1024. The step portion of the thin arm support 1014 extends upwardly from the coupling portion 1030. The support portion 1032 of the thin arm support 1014 extends from the step portion 1031 to the thin body portion 1012 and is operable to support a patient's arm. The step portion 1031 is sized such that the thin pad 1016 is flush with the top of the thick mattress pad 1024.

The thin pad 1016 is illustratively a gel pad with a thickness of about ⅛^{th} inch to about 1 inch. The thin pad 1016 overlies the thin body portion 1012 and the support portion 1032 of the thin arm support 1014. In other embodiments, the thin pad 1016 may be made from foam or other padding material. In some embodiments, the thin body 1012, the thin arm support 1014, and the thin pad 1016 may be covered by a disposable cover.

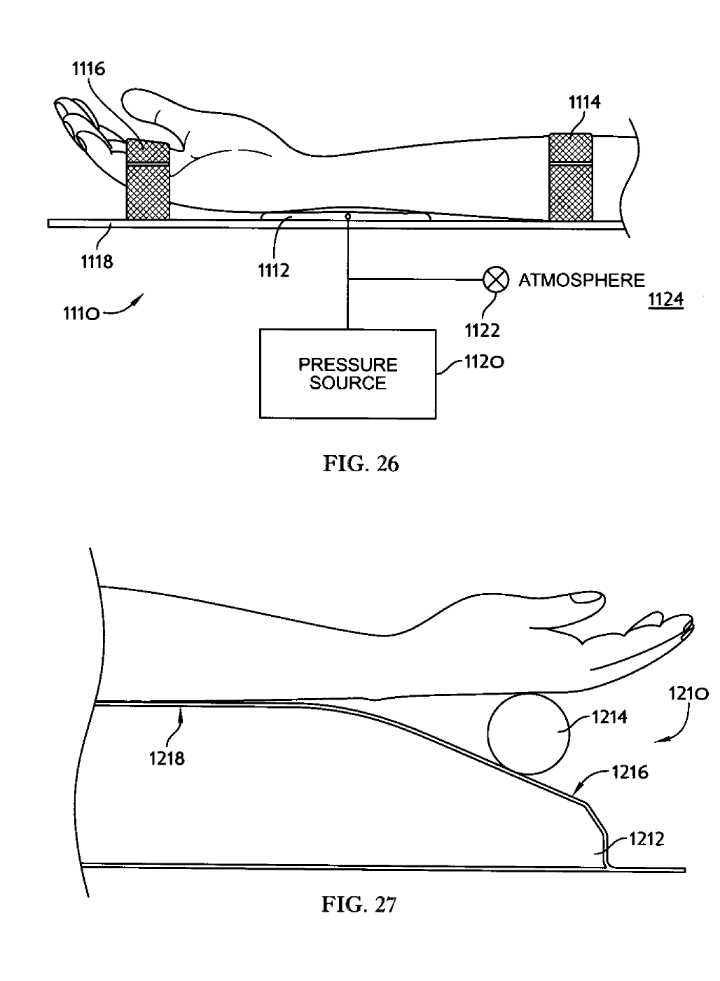

Yet another alternative positioning aid 1110 is shown in FIGS. 25 and 26. The positioning aid 1110 includes and inflatable bladder 1112, an arm strap 1114, a hand strap 1116, and an arm board 1118. The arm strap 1114 is operable to wrap around the arm board 1118 and to secure a patient's arm to the arm board 1118. The hand strap 1116 is operable to wrap around the arm board 1118 and to secure a patient's hand to the arm board 1118. The inflatable bladder 1112 is coupled to the arm board 1118 and situated between the arm strap 1114 and the hand strap 1116 so as to underlie a patient's wrist.

The inflatable bladder 1112 is coupled to a pressure source 1120 and a vent 1122. The pressure source 1120 is operable to inflate the bladder 1112. The pressure source 1120 may be a squeeze bulb, a blower, a compressor, a bellows, a compressed air tank, or any other suitable pressure source. The vent 1122 is coupled to the atmosphere 1124 and is operable to deflate the bladder 1112 when the vent is moved to an open position. The inflatable bladder 1112 is movable between a support position, shown in FIG. 25, and a recovery position, shown in FIG. 26. In the support position, the inflatable bladder 1112 is inflated by the pressure source 1120 to support a patient's wrist in a hyper-extended position. In the recovery position, the inflatable bladder 1112 is deflated by the opening the vent 1122 so that a patient's wrist is supported in a substantially flat position.

Still another alternative positioning aid 1210 is shown in FIG. 27. The aid 1210 includes a block 1212 and a removable slug 1214. The block 1212 forms a decline ramp 1216 extending downwardly from a top surface 1218 of the block 1212. The top surface 1218 of the block 1212 is operable to support a patient's arm. The slug 1214 is placed by a surgeon or a caregiver between a patient's hand and the decline ramp 1216 at the desired location. In the illustrative embodiment, the slug 1214 has a round cross section to allow the slug to be rolled down the decline ramp 1216 for removal. In other embodiments, the slug 1214 has other cross sectional shapes.

The aid 1210 is movable between a recovery position and a support position. In the recovery position, the slug 1214 is situated between the decline ramp 1216 and a patient's hand so that the patient's wrist is supported in a substantially flat configuration as shown in FIG. 27. In the support position, the slug 1214 is moved away from the decline ramp so that a patient's hand is supported by the decline ramp 1216 and a patient's wrist is supported at a hyper-extended angle.

Although certain illustrative embodiments have been described in detail above, variations and modifications exist within the scope and spirit of this disclosure as described and as defined in the following claims.

1. A surgical positioning aid comprising a sheet of foldable material foldable between a flat position and a wrist support position in which the sheet is folded to form a hump having sufficient strength to support a patient's wrist during surgery, the sheet having a coupler at a first end region of the sheet, the coupler engaging an opposite, second end region of the sheet to hold the sheet in the wrist support position.

2. The surgical positioning aid of claim 1, wherein the sheet is further foldable to a recovery position in which the sheet is folded over itself in a substantially flat configuration.

3. The surgical positioning aid of claim 2, wherein the sheet of foldable material includes a locking coupler and a locking coupler receiver and the locking coupler engages the locking coupler receiver when the sheet of foldable material is folded to the recovery position to block the sheet from unfolding.

4. The surgical positioning aid of claim 1, wherein the foldable sheet includes at least one living hinge about which the sheet is folded.

5. The surgical positioning aid of claim 4, wherein the at least one living hinge forms an apex of the hump having sufficient strength to support a patient's wrist during surgery.

6. The surgical positioning aid of claim 1, wherein the coupler at the first end region of the sheet includes a coupler tab bendable out of alignment with the sheet.

7. The surgical positioning aid of claim 6, wherein the second end region includes a series of coupler tab receivers formed through the sheet and sized to receive the coupler tab.

8. The surgical positioning aid of claim 6, wherein the coupler tab is defined by a U-shaped slot formed through the sheet.

9. A surgical positioning aid comprising a flat sheet of foldable material having first, second and third portions, the first portion being separated from the second portion by a first living hinge, the third portion being separated from the second portion by a second living hinge, wherein the sheet also has a tab and the first portion has at least one slot to receive the tab, wherein the sheet is movable between a flat position prior to use in surgery and a support position for surgery in which the second portion is folded relative to the first portion about the first living hinge and the third portion is folded relative to the second portion about the second living hinge, the tab being received in the at least one slot of the first portion when the sheet is in the support position such that the first and the second portions cooperate to form a hump relative to the first portion.

10. The surgical positioning aid of claim 9, wherein the hump includes an apex formed by the second living hinge and the apex being spaced above the first portion.

11. The surgical positioning aid of claim 10, wherein the second living hinge includes at least two series of perforations formed through the sheet providing a gradual bend.

12. The surgical positioning aid of claim 9, wherein the second portion forms a ramp between the first portion of the sheet and the first living hinge.

13. The surgical positioning aid of claim 12, wherein the third portion forms a ramp between the second living hinge and the tab.

14. The surgical positioning aid of claim 9, wherein the sheet is further movable to a recovery position wherein the second portion is folded over the first portion about the first living hinge such that the second portion overlies and is substantially parallel to the first portion and the third portion is folded relative to the second portion about the second living hinge such that the second and the third portions are substantially flat relative to one another.

15. The surgical positioning aid of claim 14, wherein the second portion includes a first locking tab and the first portion includes a first locking tab receiver sized to receive the first locking tab.

16. The surgical positioning aid of claim 15, wherein the first locking tab is received by the first locking tab receiver when the surgical positioning aid is moved to the recovery position so that the locking tab blocks the second portion from unfolding relative to the first portion about the first living hinge.

17. The surgical positioning aid of claim 9, wherein the sheet is formed to include at least one strap slot sized for a strap to extend through the at least one strap slot.

18. The surgical positioning aid of claim 17, wherein the second portion is formed to include a first strap slot and the third portion is formed to include a second strap slot.

19. The surgical positioning aid of claim 9, wherein the sheet further includes a fourth portion separated from the third portion by a third living hinge, the fourth portion formed to include a U-shaped slot defining the tab.

20. The surgical positioning aid of claim 19, wherein the fourth portion is folded relative to the third portion about the third living hinge so that the fourth portion overlies and is substantially parallel to the first portion when the surgical positioning aid is moved to the support position.
